(19) United States
(12) Patent Application Publication
(10) Pub. No.: US 2003/0236819 A1
(43) Pub. Date: Dec. 25, 2003

(54) Queue-based data retrieval and transmission

(76) Inventor: James David Greubel, Shalimar, FL (US)

Correspondence Address: FISH & RICHARDSON PC, 225 FRANKLIN ST, BOSTON, MA, 02110, US

(21) Appl. No.: 10/176,092

(22) Filed: Jun. 20, 2002

(51) Int. Cl. G06F 15/16

(52) U.S. Cl. 709/201

(57) ABSTRACT

A data retrieval process, which resides on a server, receives a transmitted data object from a network. The data retrieval process includes a transport management process for receiving a data read request from an application. A communication queue manager maintains a plurality of communication buffers. A communication management process, which is responsive to the data management process receiving the data read request from the application, receives the transmitted data object from the network and stores the transmitted data object in one or more of the communication buffers obtained from the plurality of communication buffers.

### TECHNICAL FIELD

This invention relates to queue-based data retrieval and transmission.

### BACKGROUND

Computer networks link multiple computer systems in which various programs are executed on the individual computer systems attached the network. Computer networks facilitate transfer of data between these computer systems and the programs executed on these computer systems.

Queues in these computer systems act as temporary storage areas for the computer programs executed on these computer systems. Queues allow for the temporary storage of data objects when the intended process recipient of the objects is unable to process the objects immediately upon arrival.

Queues are typically hardware-based, using dedicated portions of memory address space (i.e., memory banks) to store data objects.

### SUMMARY

According to an aspect of this invention, a data retrieval process, which resides on a server, receives a transmitted data object from a network. The data retrieval process includes a transport management process for receiving a data read request from an application. A communication queue manager maintains a plurality of communication buffers. A communication management process, which is responsive to the data management process receiving the data read request from the application, receives the transmitted data object from the network and stores the transmitted data object in one or more of the communication buffers obtained from the plurality of communication buffers.

One or more of the following features may also be included. An application queue manager maintains a plurality of application buffers accessible by the application. The communications management process includes a data object transfer process for transferring the transmitted data object stored in the communication buffers to the application buffers.

The application queue manager includes a memory apportionment process for dividing an application memory address space into the plurality of application buffers. Each application buffer has a unique memory address and the plurality of application buffers provides an application availability queue. The application queue manager includes a buffer enqueueing process for associating the application buffers, into which the transmitted data object was written, with a header cell that is associated with the application. This header cell includes a pointer for each of the application buffers, such that each pointer indicates the unique memory address of the application buffer associated with that pointer. The application queue manager includes a data object read process for allowing the application to read the transmitted data object stored in the application buffers.

The application buffers associated with the header cell constitute a FIFO queue associated with and useable by the application. The data object read process is configured to sequentially read the application buffers in the FIFO queue in the order in which the application buffers were written by the data object transfer process. The application queue manager includes a buffer dequeuing process, responsive to the data object read process reading data objects stored in the application buffers, for dissociating the application buffers from the header cell and allowing the one or more application buffers to be overwritten. The application queue manager includes a buffer deletion process for deleting the application buffers when they are no longer needed by the application queue manager.

The communication queue manager includes a memory apportionment process for dividing a communication memory address space into the plurality of communication buffers. Each communication buffer has a unique memory address and the plurality of communication buffers provides a communication availability queue. An application queue manager associates the communication buffers into which the transmitted data object was written with a header cell that is associated with the application. This header cell includes a pointer for each of the communication buffers, such that each pointer indicates the unique memory address of the communication buffer associated with that pointer. The application queue manager includes a data object read process for allowing the application to read the transmitted data object stored in the communication buffers.

The application queue manager includes a buffer dequeuing process that is responsive to the data object read process reading data objects stored in the one or more communication buffers. This buffer dequeuing process dissociates the communication buffers from the header cell and releases the communication buffers to the communication availability queue.

The transmitted data object includes an intended recipient designation, such as a socket address. The communication management process includes a designation analysis process that analyzes the transmitted data object to determine the intended recipient designation. The communication buffers are either a proprietary cache memory device or a portion of system memory. The transport management process is a transport service utility in a Unisys operating system and the communication management process is either a CMS process or a CPComm process, both in a Unisys operating system.

According to a further aspect of this invention, a method for receiving a transmitted data object from a network, includes receiving a data read request from an application and maintaining a plurality of communication buffers. The transmitted data object is received from the network and stored in one or more communication buffers that were obtained from the plurality of communication buffers.

One or more of the following features may also be included. A plurality of application buffers are maintained that are accessible by the application. The transmitted data object stored in the one or more communication buffers is transferred to the application buffers. An application memory address space is divided into the plurality of application buffers, such that each application buffer has a unique memory address and the plurality of application buffers provides an application availability queue. The application buffers, into which the transmitted data object was written, are associated with a header cell that is associated with the application. This header cell includes a pointer for each of the application buffers, such that each pointer indicates the unique memory address of the application buffer associated with that pointer. The application is allowed to read the transmitted data object stored in the application buffers. The application buffers are dissociated from the header cell and released to the application availability queue. The application buffers are deleted when they are no longer needed.

A communication memory address space is divided into the plurality of communication buffers, such that each communication buffer has a unique memory address and the plurality of communication buffers provides a communication availability queue. The communication buffers into which the transmitted data object was written are associated with a header cell that is associated with the application. This header cell includes a pointer for each of the communication buffers, such that each pointer indicates the unique memory address of the communication buffer associated with that pointer. The application is allowed to read the transmitted data object stored in the communication buffers. The communication buffers are dissociated from the header cell and released to the communication availability queue. The transmitted data object is analyzed to determine the intended recipient designation.

According to a further aspect of this invention, a computer program product resides on a computer readable medium that stores a plurality of instructions. When executed by the processor, these instructions cause the processor to receive a data read request from an application and maintain a plurality of communication buffers. A transmitted data object is received from a network and stored in one or more communication buffers obtained from the plurality of communication buffers.

According to a further aspect of this invention, a data transmission process, which resides on a server and transmits a data object over a network, includes an application queue manager for maintaining a plurality of application buffers accessible by an application. This application queue manager includes a data object write process for allowing an application to write the data object to be transmitted over the network into one or more of the application buffers obtained from the plurality of application buffers. A transport management process receives a data send request from the application. A communication management process, which is responsive to the data management process receiving the data send request from the application, transmits the data object over the network.

One or more of the following features may also be included. The application queue manager includes a memory apportionment process for dividing an application memory address space into the plurality of application buffers, such that each application buffer has a unique memory address and the plurality of application buffers provides an application availability queue. A communication queue manager associates the one or more application buffers, into which the data object was written, with a header cell that is associated with the communication queue manager. This header cell includes a pointer for each of the one or more application buffers, such that each pointer indicates the unique memory address of the application buffer associated with that pointer. The communication queue manager includes a buffer dequeuing process, which is responsive to the communication management process transmitting the data object over the network, for dissociating the one or more application buffers from the header cell and releasing them to the application availability queue. The communication buffers are each a proprietary cache memory device or a portion of system memory. The transport management process is a transport service utility in a Unisys operating system. The communication management process is a either a CMS process or a CPComm process in a Unisys operating system.

According to a further aspect of this invention, a method for transmitting a data object over a network, includes maintaining a plurality of application buffers accessible by an application. This application is allowed to write the data object to be transmitted over the network into one or more of the application buffers obtained from the plurality of application buffers. A data send request is received from the application and the data object is transmitted over the network.

One or more of the following features may also be included. An application memory address space is divided into the plurality of application buffers, such that each application buffer has a unique memory address and the plurality of application buffers provides an application availability queue. One or more application buffers, into which the data object was written, are associated with a header cell. This header cell includes a pointer for each of the application buffers, such that each pointer indicates the unique memory address of the application buffer associated with that pointer. One or more application buffers are dissociated from the header cell and released to the application availability queue. The communication buffers are each a proprietary cache memory device or a portion of system memory.

According to a further aspect of this invention, a computer program product resides on a computer readable medium and has a plurality of instructions stored on it. When executed by the processor, these instructions cause that processor to maintain a plurality of application buffers accessible by an application. An application is allowed to write the data object to be transmitted over the network into one or more of the application buffers obtained from the plurality of application buffers. A data send request is received from the application, and the data object is transmitted over the network.

One or more advantages can be provided from the above. The data transmission and retrieval process can be streamlined. Further, by passing queue pointers, as opposed to actual data, between the application and the communications processes, throughput can be increased. Additionally, the use of queues allows for dynamic configuration in response to the number and type of applications running on the system. Accordingly, system resources can be conserved and memory usage made more efficient.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a data retrieval process;

FIG. 2 is a block diagram of an application queue manager of the data retrieval process;

FIG. 3 is a block diagram of a communication queue manager of the data retrieval process;

FIG. 4 is a block diagram of a data transmission process;

FIG. 5 is a flow chart depicting a data retrieval method; and

FIG. 6 is a flow chart depicting a data transmission method.

### DETAILED DESCRIPTION

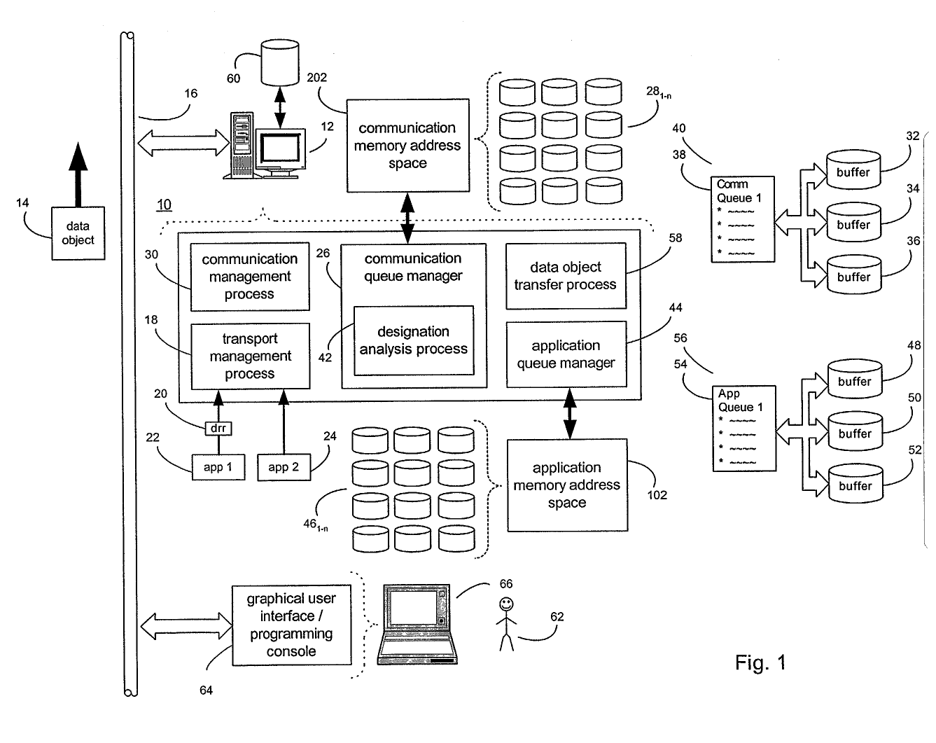

Referring to FIG. 1, there is shown a data retrieval process 10, which resides on server 12 and retrieves a transmitted data object 14 from network 16. Transmitted data object 14 is transmitted from a remote computer (not shown). A transport management process 18 (such as the Transport Service Utility in the Unisys® operating system) receives a data read request 20 from one of the applications 22, 24 that run on server 12. A communication queue manager 26 maintains a plurality of communication buffers 28₁₋ₙ that are accessible by a communication management process 30.

Whenever transport management process 18 receives a data read request 20, communication management process 30 (such as CMS or CPComm in the Unisys® operating system) retrieves the transmitted data object 14 from network 16. This transmitted data object 14 is stored in one or more communication buffers 32, 34, 36 provided from the communication buffers 28₁₋ₙ and maintained by communication queue manager 26. These communication buffers 32, 34, 36, in combination with a header cell also referred to as a queue cell 38 (to be discussed below in greater detail) form a communication queue 40 that is accessible by communication management process 30. The specific number of buffers 32, 34, 36 included in communication queue 40 varies depending on (among other things) the size of the transmitted data object 14. For example, if transmitted data object 14 is thirty-two bytes long and the buffers 28₁₋ₙ that are available are four bytes long each, eight of these four byte buffers would be needed to store transmitted data object 14.

An application queue manager 44, which is similar to communication queue manager 26, maintains a plurality of application buffers 46₁₋ₙ that are accessible by, e.g., the applications 22, 24 running on server 12. One or more 48, 50, 52 of these application buffers 46₁₋ₙ are used, in combination with a header cell 54, to produce an application queue 56. When a transmitted data object 14 is retrieved from network 16, it is temporarily written into buffers 32, 34, 36. As the intended recipient of this data object 14 is an application (e.g., application 22 or 24), this data object 14 should be made available to the application that submitted the data read request 20 to transport management process 18. This data object 14 is made available in a couple of ways, each of which will be discussed below in greater detail. Accordingly, data object 14 may be transferred from communication buffers 32, 34, 36, to application buffers 48, 50, 52 that are accessible by the intended recipient, i.e., the application that requested data object 14. Alternatively, the ownership of these communication buffers 32, 34, 36, which belong to communication queue 40, may be transferred to application queue 56. If the data object is transferred from communication buffers 32, 34, 36, to application buffers 48, 50, 52, a data object transfer process 58 fulfills this transfer. This will also be discussed below in greater detail.

Process 10 typically resides on a storage device 60 connected to server 12. Storage device 60 can be a hard disk drive, a tape drive, an optical drive, a RAID array, a random access memory (RAM), or a read-only memory (ROM), for example. Server 12 is connected to a distributed computing network 16 , such as the Internet, an intranet, a local area network, an extranet, or any other form of network environment. Process 10 is generally executed in main memory, e.g., random access memory.

Process 10 is typically administered by an administrator using a graphical user interface or a programming console 64 running on a remote computer 66, which is also connected to network 16. The graphical user interface can be a web browser, such as Microsoft Internet Explorer™ or Netscape Navigator™. The programming console can be any text or code editor coupled with a compiler (if needed).

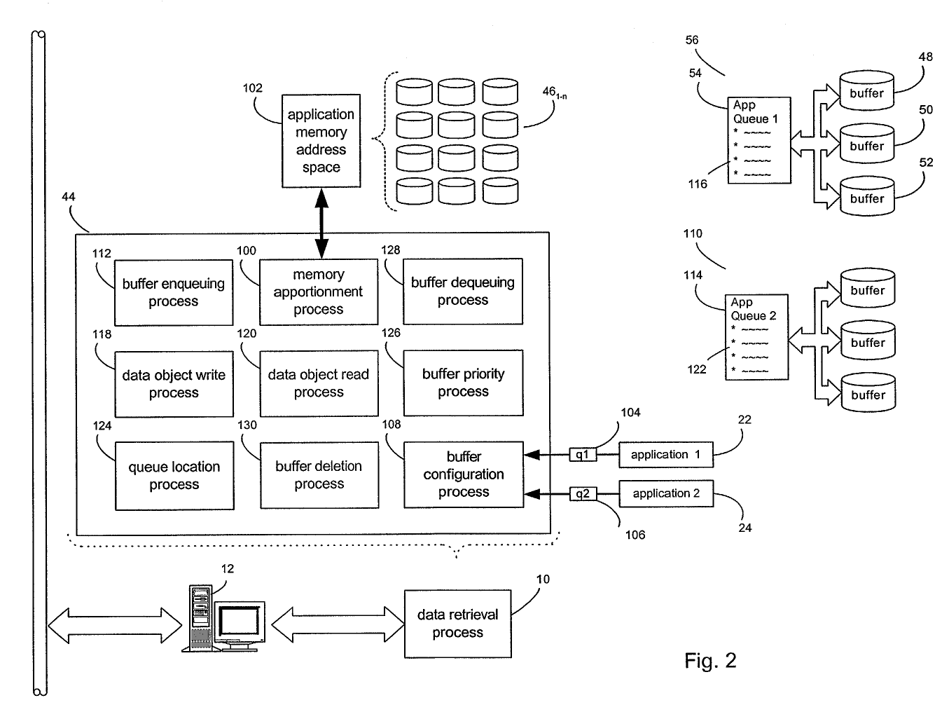

Referring to FIGS. 1 and 2, application queue manager 44 includes a memory apportionment process 100 for dividing application memory address space 102 into multiple application buffers 461₁₋ₙ. These buffers 46₁₋ₙ are used to assemble whatever queues (e.g., application queue 56) are required by applications 22, 24.

Application memory address space 102 can be any type of memory storage device such as DRAM (dynamic random access memory), SRAM (static random access memory), or a hard drive, for example. Further, the quantity and size of application buffers 46₁₋ₙ produced by memory apportionment process 100 vary depending on the individual needs of the applications 22, 24 running on server 12.

Since each of the application buffers 46₁₋ₙ represents a physical portion of application memory address space 102, each application buffer has a unique memory address associated with it, namely the physical address of that portion of application memory address space 102. Typically, this address is an octal address. Once application memory address space 102 is divided into application buffers 46₁₋ₙ, this pool of application buffers is known as an application availability queue, as this pool represents the application buffers available for use by application queue manager 44.

Upon the startup of an application 22, 24 running on server 12 (or upon the booting of server 12 itself), the individual queue parameters 104, 106 of the applications 22, 24 respectively running on server 12 are determined. These queue parameters 104, 106 typically include the starting address for the application queue (typically an octal address), the depth of the application queue (typically in words), and the width of the application queue (typically in words), for example.

Application queue manager 44 includes a buffer configuration process 108 that determines these queue parameters 104, 106. While two applications are shown (namely 22, 24), this is for illustrative purposes only, as the number of applications deployed on server 12 varies depending on the particular use and configuration of server 12. Additionally, process 108 is performed for each application running on server 12. For example, if application 22 requires ten queues and application 24 requires twenty queues, buffer configuration process 108 would determine the queue parameters for thirty queues, in that application 22 would provide tens sets of queue parameters and application 24 would provide twenty sets of queue parameters.

Typically, when an application is launched (i.e., loaded), that application proactively provides queue parameters 104, 106 to buffer configuration process 108. Alternatively, these queue parameter 104, 106 may be reactively provided to buffer configuration process 108 in response to that process 108 requesting them.

Each of the applications 22, 24 usually include a batch file (not shown) that executes when the application launches. The batch files specifies the queue parameters (or the locations thereof) so that the queue parameters can be provided to buffer configuration process 108. Further, this batch file may be reconfigured and/or re-executed in response to changes in the application's usage, loading, etc. For example, assume that the application in question is a database application and the queuing requirements of this database application are proportional to the number of records within a database managed by the database application. Accordingly, as the number of records increase, the number and/or size of the queues should also increase. Therefore, the batch file that specifies (or includes) the queuing requirements of this database application may re-execute when the number of records in the database increases to a level that requires enhanced queuing capabilities. This allows for the queuing to dynamically change without having to relaunch the application, which is usually undesirable in a server environment.

Once the queue parameters 104, 106 for the applications 22, 24 are received by buffer configuration process 108, memory apportionment process 100 divides application memory address space 102 into the appropriate number and size of application buffers. For example, if application 22 requires one queue (e.g., application queue 56) that includes four, one-word buffers; the queue depth of queue 56 is four words and the queue width (i.e., the buffer size) is one word. Additionally, if application 24 requires one queue (e.g., application queue 110) that includes eight, one-word buffers; the queue depth of queue 110 is eight words and the queue width is one word. Summing up:

| | Queue Width (in | |
|---|---|---|
| Queue Name | words) | Queue Depth (in words) |
| Application Queue 56 | 1 | 4 |
| Application Queue 110 | 1 | 8 |

Upon determining the parameters of the two application queues that are needed (one of which is four words deep and another eight words deep), twelve one-word application buffers 46₁₋ₙ are carved out of application memory address space 102 by memory apportionment process 100. These twelve one-word application buffers are the availability queue for application queue manager 44. Since twelve buffers are needed, only twelve buffers are produced and the entire application memory address space 102 is not carved up into buffers. Therefore, the remainder of application memory address space 102 can be used by other programs for general “non-queuing” storage functions.

Continuing with the above-stated example, if application memory address space 102 is two-hundred-fifty-six-kilobytes of SRAM, the address range of that address space is 000000-777777 _{base 8}. Since each of these twelve buffers is configured dynamically in application memory address space 102 by memory apportionment process 100, each buffer has a unique starting address within that address range of application memory address space 102. For each buffer, the starting address of that buffer in combination with the width of the queue (i.e., that queue's buffer size) maps the memory address space of that buffer. Assume that server 12 is a thirty-two bit system running a thirty-two bit network operating system (NOS) and, therefore, each thirty-two bit data chunk is made up of four eight-bit words. Assuming also that memory apportionment process 100 assigns a starting memory address of 000000 _{base 8} for Buffer 1, for the twelve buffers described above, the memory maps of their address spaces is as follows:

| Buffer | Starting Address _{base 8} | Ending Address _{base 8} |
|---|---|---|
| Buffer 1 | 000000 | 000003 |
| Buffer 2 | 000004 | 000007 |
| Buffer 3 | 000010 | 000013 |
| Buffer 4 | 000014 | 000017 |
| Buffer 5 | 000020 | 000023 |
| Buffer 6 | 000024 | 000027 |
| Buffer 7 | 000030 | 000033 |
| Buffer 8 | 000034 | 000037 |
| Buffer 9 | 000040 | 000043 |
| Buffer 10 | 000044 | 000047 |
| Buffer 11 | 000050 | 000053 |
| Buffer 12 | 000054 | 000057 |

Since, in this example, the individual buffers are each thirty-two bit buffers (comprising four eight-bit words), the address space of Buffer 1 is 000000-000003 _{base 8}, for a total of four bytes. Therefore, the total memory address space used by these twelve buffers is forty-eight bytes and the vast majority of the two-hundred-fifty-six kilobytes of application memory address space 102 is not used. However, in the event that additional applications are launched on server 12 or the queuing needs of applications 22, 24 change, additional portions of application memory address space 102 will be subdivided into buffers.

At this point, an application availability queue having twelve buffers is available for assignment. A buffer enqueuing process 112 assembles the queues required by the applications 22, 24 from the application buffers 46₁₋ₙ available in the application availability queue. Specifically, buffer enqueuing process 112 associates a header cell 54, 114 with one or more of these twelve buffers 46₁₋ₙ. These header cells 54, 114 are address lists that provide information (in the form of pointers 116, 122) concerning the starting addresses of the individual buffers that make up the queues.

Continuing with the above-stated example, application queue 56 is made of four one-word buffers and application queue 110 is made of eight one-word buffers. Accordingly, buffer enqueuing process 112 may assembly application queue 56 from Buffers 1-4 and assemble application queue 110 from Buffers 5-12. Therefore, the address space of application queue 56 is from 000000-000017 _{base 8}, and the address space of application queue 110 is from 000020-000057 _{base 8}. The content of header cell 54 (which represents application queue 56, i.e., the four word queue) is as follows:

Application Queue 56
000000
000004
000010
000014

The values 000000, 000004, 00010, and 000014 are pointers that point to the starting address of the individual buffers that make up application queue 56. These values do not represent the content of the buffers themselves and are only pointers 116 that point to the buffers containing the data objects. To determine the content of the buffer, the application would have to access the buffer referenced by the appropriate pointer.

The content of header cell 114 (which represents application queue 110, i.e., the eight word queue) is as follows:

Application Queue 110
000020
000024
000030
000034
000040
000044
000050
000054

Typically, the queue assembly handled by buffer enqueuing process 112 is performed dynamically. That is, while the queues were described above as being assembled prior to being used, this was done for illustrative purposes only, as the queues are typically assembled on an “as needed” basis. Specifically, header cells 54, 114 would be empty when application queues 56, 110 were first produced. For example, header cell 54, which represents application queue 56 (the four word queue), would be an empty table that includes four place holders into which the addresses of the specific buffers used to assemble that queue will be inserted. However, these address are typically not added (and therefore, the buffers are typically not assigned) until the buffer in question is written to. Therefore, an empty buffer is not referenced in a header cell and not assigned to a queue until a data object is written into it. Until this write procedure occurs, these buffers remain in the application availability queue.

Continuing with the above-stated example, when an application wishes to write to a queue (e.g., application queue 56), that application references that queue by the header (e.g., “App. Queue 1”) included in the appropriate header cell 54. This header is a unique identifier used to identify the queue in question. When a data object is received for (or from) the application associated with, for example, the header cell 54 (e.g., application 22 for application queue 56), buffer enqueuing process 112 first obtains a buffer (e.g., Buffer 1) from the application availability queue and then the data object received is written to that buffer. Once this writing procedure is completed, header cell 54 is updated to include a pointer that points to the address of the buffer (e.g., Buffer 1) recently associated with that header cell.

Further, once this buffer (e.g., Buffer 1) is read by an application, that buffer is released from the header cell 54 and is placed back into the availability queue. Accordingly, the only way in which every buffer in the availability queue is used is if every buffer is full and waiting to be read.

Concerning buffer read and write operations, a data object write process 118 writes data objects into application buffers 46₁₋ₙ and a data object read process 120 reads data objects stored in the buffers. As will be discussed below in greater detail, data object read process 118 and data object write process 120 interact with communication queue manager 26.

Typically, the application queues produced by an application are readable and writable only by the application that produced the application queue. However, these application queues may be configured to be readable and/or writable by any application or process, regardless of whether or not they were produced by that application or process. If this cross-platform access is desired, process 44 includes a queue location process 124 that allows an application or process to locate an application queue (provided the name of the header cell associated with that queue is known) so that the application or process can access that queue.

Application queues assembled by buffer enqueuing process 112 are typically FIFO (first in, first out) queues, in that the first data object written to the application queue is the first data object read from the application queue. However, a buffer priority process 126 allows for adjustment of the order in which the individual buffers within an application queue are read. This adjustment can be made in accordance with the priority level of the data objects stored within the buffers. For example, higher priority data objects could be read before lower priority data objects in a fashion similar to that of interrupt prioritization within a computer system.

As stated above, when a buffer within an application queue is read by data object read process 120, that buffer is typically released back to the application availability queue so that future incoming data objects can be written to that buffer. A buffer dequeuing process 128, which is responsive to the reading of a data object stored in a buffer, dissociates that recently read buffer from the header cell. Accordingly, continuing with the above stated example, once the content of Buffer 1 is read by data object read process 120, Buffer 1 is released (i.e., dissociated) and, therefore, the address of Buffer 1 (i.e., 000000 _{base 8}) that was a pointer within header cell 54 is removed. Accordingly, after buffer dequeuing process 128 removes this pointer (i.e., the address of Buffer 1) from header cell 54, this header cell 54 is once again empty.

Header cell 54 is capable of containing four pointers which are the four addresses of the four buffers associated with that header cell and, therefore, application queue 56. When application queue 56 is empty, so are the four place holders that can contain these four pointers. As data objects are received for application queue 56, data object write process 118 writes each of these data objects to an available application buffer obtained from the application availability queue. Once this write process is complete, buffer enqueuing process 112 associates each of these now-written buffers with application queue 56. This association process modifies the header cell 54 associated with application queue 56 to include a pointer that indicates the memory address of the buffer into which the data object was written. Once this data object is read from the buffer by data object read process 120, the pointer that points to that buffer is removed from header cell 54 and the buffer will once again be available in the application availability queue. Therefore, header cell 54 only contains pointers that point to buffers containing data objects that need to be read. Accordingly, for header cell 54 and application queue 56, when application queue 56 is full, header cell 54 contains four pointers, and when application queue 56 is empty, header cell 54 contains zero pointers.

As the header cells incorporate pointers that point to data objects (as opposed to incorporating the data objects themselves), transferring data objects between queues is simplified. For example, if application 22 (which uses application queue 56) has a data object stored in Buffer 3 (i.e., 000010 _{base 8}) and this data object needs to be processed by application 24 (which uses application queue 110), buffer dequeuing process 128 could dissociate Buffer 3 from header cell 54 for application queue 56 and buffer enqueuing process 112 could then associate Buffer 3 with header cell 114 for application queue 110. This would result in header cell 54 being modified to remove the pointer that points to memory address 000010 _{base 8} and header cell 114 being modified to add a pointer that points to 000010 _{base 8}. This results in the data object in question being transferred from application queue 56 to application queue 110 without having to change the location of that data object in memory. As will be discussed below in greater detail, data object transfers may also occur between application queue manager 44 and communication queue manager 26.

In the event that the queuing needs of an application are reduced or an application is closed, the header cell(s) associated with this application would be deleted. Accordingly, when header cells are deleted, the total number of buffers required for the application availability queue are also reduced. A buffer deletion process 130 deletes these buffer so that these portions of application memory address space 102 can be used by some other storage procedure.

Continuing with the above-stated example, if application 24 was closed, header cell 114 would no longer be needed. Additionally, there would be a need for eight less buffers, as application 24 specified that it needed a queue that was one word wide and eight words deep. Accordingly, eight one-word buffers would no longer be needed and buffer deletion process 130 would release eight buffers (e.g., Buffers 5-12) so that these thirty-two bytes of storage would be available to other programs or procedures.

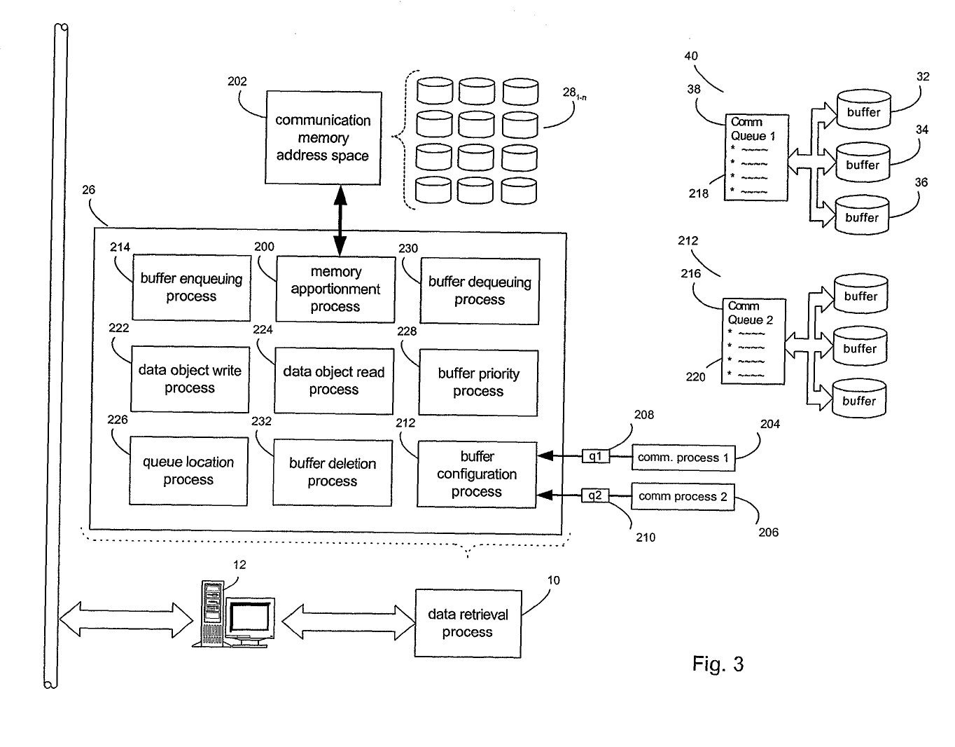

Referring to FIGS. 1, 2, and 3, communication queue manager 26 is described in detail. Similar to application queue manager 44, communication queue manager 26 configures and maintains communication queues for use by communication management process 30. Communication queue manager 26 includes a memory apportionment process 200 for dividing communication memory address space 202 into multiple application buffers 28₁₋ₙ. These buffers 28₁₋ₙ are used to assemble whatever queues (e.g., communication queue 40) are required by the communication processes 204, 206 that are being managed by communication management process 30. For example, if a data object 14 is being received and temporarily stored, the retrieval process that is receiving that data object is a communication process.

As with the application memory address space, communication memory address space 202 can be any type of memory storage device such as DRAM (dynamic random access memory), SRAM (static random access memory), or a hard drive, for example. Further, communication memory address space 202 and application memory address space 102 may be discrete portions of one physical block of memory (e.g., system RAM).

The quantity and size of communication buffers 28₁₋ₙ produced by memory apportionment process 200 varies depending on the individual needs of the processes 204, 206 running on server 12.

Since each of the communication buffers 28₁₋ₙ represents a physical portion of communication memory address space 202, each communication buffer has a unique memory address associated with it. This unique memory address (typically octal) is the physical address of that portion of communication memory address space 202. Once communication memory address space 202 is divided into communication buffers 28₁₋ₙ, this pool of communication buffers is known as a communication availability queue, as this pool represents the communication buffers available for use by communication queue manager 26.

Upon the startup of communication processes 204, 206 running on server 12 (or upon the booting of server 12 itself), the individual queue parameters 208, 210 of the processes 204, 206 respectively running on the server are determined. Similar to the queue parameters for application queues, these queue parameters 208, 210 may include the starting address for the communication queue (typically an octal address), the depth of the communication queue (typically in words), and the width of the communication queue (typically in words), for example.

Communication queue manager 26 includes a buffer configuration process 212 that determines these queue parameters 208, 210. While only two processes 204, 206 are shown, this is for illustrative purposes only, as the number of processes deployed varies depending on the requirements and utilization of communication management process 30.

Buffer configuration process 212 is performed for each process being executed by communication management process 30. For example, if process 204 requires five queues and process 206 requires ten queues, buffer configuration process 212 would determine the queue parameters for fifteen queues, in that process 204 would provide five sets of queue parameters and process 206 would provide ten sets of queue parameters.

These queue parameters 208, 210 may be the same regardless of the process being executed by communication management process 30. Alternatively, these parameters may be tailored depending on the type of process being executed. For example, if process 204 is receiving a data stream in which the data objects received are sixty-four bytes long, the queue parameters 208 for this process 204 may specify a queue width of sixty-four bytes. Alternatively, if process 206 is receiving data objects that are sixteen bytes long, the queue parameters 210 for this process may specify a queue width of sixteen bytes.

Once the queue parameters 208, 210 for the processes 204, 206 are received by buffer configuration process 212, memory apportionment process 200 divides communication memory address space 202 into the appropriate number and size of communication buffers 28₁₋ₙ. If process 204 requires one queue (e.g., communication queue 40) that includes two, one-word buffers; the queue depth of communication queue 40 is two words and the queue width (i.e., the buffer size) is one word. Additionally, if process 206 requires one queue (e.g., communication queue 212) that includes ten, one-word buffers; the queue depth of communication queue 212 is ten words and the queue width is one word. Summing up:

| | Queue Width (in | |
|---|---|---|
| Queue Name | words) | Queue Depth (in words) |
| Communication Queue 40 | 1 | 2 |
| Communication Queue 212 | 1 | 10 |

Upon determining the parameters of the two communication queues 40, 212 that are needed (one of which is two words deep and the other ten words deep), twelve one-word communication buffers 28₁₋ₙ are carved out of communication memory address space 202 by memory apportionment process 200. These twelve one-word communication buffers are the availability queue for communication queue manager 26.

As with application buffers, each of these twelve communication buffers is configured dynamically in communication memory address space 202 by memory apportionment process 200. Therefore, each communication buffer has a unique starting address within that address range of communication memory address space 202. For each communication buffer, the starting address of that buffer in combination with the width of the queue (i.e., that queue's buffer size) maps the memory address space of that buffer. Again, assume that server 12 is a thirty-two bit system and, therefore, each thirty-two bit data chunk is made up of four eight-bit words. Assuming that memory apportionment process 200 assigns a starting memory address of 000000 _{base 8} for Buffer 1, for the twelve buffers described above, the memory maps of their address spaces is as follows:

| Buffer | StartingAddress _{base 8} | EndingAddress _{base 8} |
|---|---|---|
| Buffer 1 | 000000 | 000003 |
| Buffer 2 | 000004 | 000007 |
| Buffer 3 | 000010 | 000013 |
| Buffer 4 | 000014 | 000017 |
| Buffer 5 | 000020 | 000023 |
| Buffer 6 | 000024 | 000027 |
| Buffer 7 | 000030 | 000033 |
| Buffer 8 | 000034 | 000037 |
| Buffer 9 | 000040 | 000043 |
| Buffer 10 | 000044 | 000047 |
| Buffer 11 | 000050 | 000053 |
| Buffer 12 | 000054 | 000057 |

Since, in this example, the individual communication buffers are each thirty-two bit buffers (comprising four eight-bit words), the address space of Buffer 1 is 000000-000003 _{base 8}, for a total of four bytes. Therefore, the total memory address space used by these twelve communication buffers is forty-eight bytes. In the event that additional processes (e.g., another communication session) are launched by communication management process 30, additional portions of communication memory address space 202 are subdivided into communication buffers.

The addresses of the twelve communication buffers are identical to that of the twelve application buffers. If a common block of memory is used for both communication memory address space 202 and application memory address space 102, the twelve communication buffers would have different physical addresses than the twelve application buffers.

The communication availability queue now includes twelve communication buffers that are available for assignment. A buffer enqueuing process 214 assembles the queues required by the processes 204, 206 from the communication buffers 28₁₋ₙ available in the communication availability queue. Specifically, buffer enqueuing process 214 associates a header cell 38, 216 with one or more of these twelve communication buffers 28₁₋ₙ. These header cells 38, 216 are address lists that provide information (in the form of pointers 218, 220) concerning the starting addresses of the individual communication buffers that make up the communication queues.

Continuing with the above-stated example, communication queue 40 is made of two one-word buffers and communication queue 212 is made of ten one-word buffers. Accordingly, buffer enqueuing process 214 may assembly communication queue 40 from Buffers 1-2 and assemble communication queue 212 from Buffers 3-12. Therefore, the address space of communication queue 40 is from 000000-000007 _{base 8}, and the address space of communication queue 212 is from 000010-000057 _{base 8}. The content of header cell 38 (which represents communication queue 40, i.e., the two word queue) is as follows:

Communication Queue 40
000000
000004

The values 000000 and 000004 are pointers that point to the starting address of the individual buffers that make up communication queue 40. These values do not represent the content of the buffers themselves and are only pointers 218 that point to the buffers containing the data objects. To determine the content of the buffer, the application would have to access the buffer referenced by the appropriate pointer.

The content of header cell 216 (which represents communication queue 212, i.e., the ten word queue) is as follows:

Communication Queue 212
000010
000014
000020
000024
000030
000034
000040
000044
000050
000054

As with application queue manager 44, the buffer enqueuing process 214 of communication queue manager 26 dynamically assembles the queues 40, 212, in that the queues are typically assembled on an “as needed” basis and header cells 38, 216 are typically empty until the queues these header cells represent (i.e., communication queues 40, 212 respectively) are written to.

Continuing with the above-stated example, when a communication process wishes to write to a queue (e.g., communication queue 40), that process references that queue by the header (e.g., “Comm. Queue 1”) included in the appropriate header cell 38. As with application queues, this header is a unique identifier used to identify the communication queue in question.

When a data object is received from (or for) the process associated with, for example, the header cell 38 (e.g., process 204 for communication queue 40), buffer enqueuing process 214 first obtains a communication buffer (e.g., Buffer 1) from the communication availability queue and then the data object received from network 16 is written to that buffer. Once this writing procedure is completed, header cell 38 is updated to include a pointer that points to the address of the communication buffer (e.g., Buffer 1) recently associated with that header cell. Further, once this communication buffer (e.g., Buffer 1) is read by an application, that buffer is released from the header cell 38 and is placed back into the communication availability queue. As with the application availability queue, the only way in which every communication buffer in the communication availability queue is used is if every communication buffer is full and waiting to be read. Concerning buffer read and write operations, a data object write process 222 writes data objects into communication buffers 28₁₋ₙ and a data object read process 224 reads data objects stored in the communication buffers.

Communication queues produced by a process are typically readable and writable only by the process that produced the communication queue. However, like the application queues, these communication queues may also be configured to be readable and/or writable by any other process or application (e.g., applications 22, 24), regardless of whether or not they produced the communication queue. If this cross-platform access is desired, process 26 includes a queue location process 226 that allows an application or process to locate a communication queue (provided the name of the header cell associated with that communication queue is known) so that the application or process can access that queue.

As with application queues, communication queues assembled by buffer enqueuing process 214 are typically FIFO (first in, first out) queues. Therefore, the first data object written to the communication queue is typically the first data object read from the communication queue.

A buffer priority process 228 allows for adjustment of the order in which the individual communication buffers within a communication queue are read.

When a buffer within a communication queue is read by data object read process 224, that buffer is typically released back to the communication availability queue so that future incoming data objects can be written to that buffer. A buffer dequeuing process 230, responsive to the reading of a data object stored in a buffer, dissociates that recently read buffer from the header cell.

Continuing with the above stated example, once the content of Buffer 1 is read by data object read process 224, Buffer 1 is released (i.e., dissociated) and, therefore, the address of Buffer 1 (i.e., 000000 _{base 8}) that was a pointer within header cell 38 is removed. Accordingly, after buffer dequeuing process 230 removes this pointer (i.e., the address of Buffer 1) from header cell 38, this header cell 38 is once again empty.

Header cell 38 is capable of containing two pointers which are the two addresses of the two buffers associated with that header cell and, therefore, communication queue 40. When communication queue 40 is empty, so are these two place holders.

As data objects are received for communication queue 40, data object write process 222 writes each of these data objects to an available buffer obtained from the communication availability queue. Once this write process is complete, buffer enqueuing process 214 associates each of these now-written buffers with communication queue 40. This association process modifies the header cell 38 associated with communication queue 40 to include a pointer that indicates the memory address of the buffer into which the data object was written. Once this data object is read from the buffer by data object read process 224, the pointer that points to that buffer is removed from header cell 38 and the buffer will once again be available in the communication availability queue. Therefore, header cell 38 only contains pointers that point to buffers containing data objects that need to be read. Accordingly, for header cell 38 and communication queue 40, when communication queue 40 is full, header cell 38 contains two pointers, and when communication queue 40 is empty, header cell 38 contains zero pointers.

Since the header cells incorporate pointers that point to data objects (as opposed to incorporating the data objects themselves), transferring data objects between communication queues is simplified. For example, if process 204 (which uses communication queue 40) has a data object stored in Buffer 2 (i.e., 000004 _{base 8}) and this data object needs to be processed by process 206 (which uses communication queue 212), buffer dequeuing process 230 could dissociate Buffer 2 from the header cell 38 for communication queue 40 and buffer enqueuing process 214 could then associate Buffer 2 with header cell 216 for communication queue 212. This would result in header cell 38 being modified to remove the pointer that points to memory address 000004 _{base 8} and header cell 216 being modified to add a pointer that points to 000004 _{base 8}. Accordingly, the data object in question was transferred from communication queue 40 to communication queue 212 without changing the location of that data object in communication memory address space 202.

As with application queues, in the event that the queuing needs of a communication process are reduced or a process is closed, the header cell(s) associated with this process would be deleted, resulting in a reduction of the total number of buffers required for the communication availability queue. A buffer deletion process 232 deletes these buffer so that these portions of communication memory address space 202 can be used by some other storage procedure.

Continuing with the above-stated example, if process 206 was closed (e.g., a download from network 16 completed and the session was closed), header cell 216 would no longer be needed. Additionally, there would be a need for ten less buffers, as process 204 specified that it needed a queue that was one word wide and ten words deep. Accordingly, ten one-word buffers would no longer be needed and buffer deletion process 232 would release ten buffers (e.g., Buffers 3-12) so that these forty bytes of storage would be available to other programs or procedures.

Now that the operation of the subsystems (i.e., application queue manager 44 and communication queue manager 26) of data retrieval process 10 have been discussed, the overall operation of data retrieval process 10 will de discussed.

As described above, whenever an application (e.g., application 22, 24) is started, the individual queue requirements for that applications are determined. Application queue manager 44 produces whenever application queues are required for that application to operate properly.

When an application (e.g., application 22, 24) wishes to receive a data object 14 being transmitted over network 16, that application provides a data read request 20 to transport management process 18. Since the data object 14 to be retrieved from network 16 should be stored, communication queue manager 26 maintains communication buffers 28₁₋ₙ that are assembled into communication queues (e.g., queues 40, 56) that are used to temporarily store data object 14 and future data objects.

Typically, multiple data objects or streams of data objects (as opposed to a single data object) are retrieved and, therefore, data retrieval process 10 tends to maintain connections over extended periods of time. These connections are sometimes referred to as communication sessions.

Accordingly, communication queue manager 26 configures any communication queues in accordance with the needs of the data stream and the application providing the data read request. For example, if the connection between server 12 and the remote system (not shown) providing data object 14 is a high speed connection, the communication queue may be larger in size to accommodate the higher rate at which the data objects are going to be received. Further, since the data objects eventually have to be transferred to the application that issued the data read request, the frequency at which the application retrieves (or is provided) the data objects also impacts the size of the communication queue. Accordingly, if the data objects are provided to the application at a high rate of frequency, a smaller communication queue can be used. Conversely, as this rate decrease, the size of the communication queue should increase.

Once the data read request 20 is received by transport management process 18, communication management process 30 obtains a communication queue 38 from communication queue manager 26. This communication queue 38 is used to temporarily store the data object 14 that is going to be received from network 16.

Continuing with the above-stated example, if application 22 sends a data read request 20 to transport management process 18, communication management process 30 is notified and communication queue manger 26 is contacted to obtain temporary storage space for data object 14. Communication queue manager 26 assigns, for example, communication queue 40 (which has two one-word, buffers, each of which is four bytes wide) to this temporary storage task (i.e., temporary storage of data object 14). Communication management process 30 then receives data object 14 (which, in this example, is a single four-byte word) from network 16. This data object 14 is then provided to communication queue manager 26 so that data object write process 222 can write data object 14 into Buffer 1 (i.e., the first available buffer in the communication availability queue). Accordingly, data object 14 is now stored in communication memory address space at physical address 000000 _{base 8}. Now that Buffer 1 has been written to, buffer enqueueing process 214 of communication queue manager 26 modifies the header cell 38 associated with communication queue 40 to include a pointer that indicates the physical address of the buffers assigned to that queue. In this particular example, header cell 38 would appear as follows:

Communication Queue 40
000000

Data object 14 is analyzed to determine the intended recipient of data object 14. This intended recipient designation (not shown) is typically in the form of a socket or port address. As stated above, when data is to be transferred or received between two computers, a communication session or process (e.g., process 204, 206) is established in which the transmitting computer transmits data to a software socket or port of the receiving computer. As these sessions or processes are established in response to a data read request being received from an application and each session or process has a socket or port associated with it, when a received data object is addressed to certain socket or port, the intended recipient of that data object (i.e., the application that established the communication session or process) is easily determined. A designation analysis process 42 analyzes the data object 14 stored in Buffer 1 to determine its intended recipient. In this example, the intended recipient is the application that made the data read request (i.e., application 22).

Now that the intended recipient of data object 14 (which is currently stored in Buffer 1 of communication queue 40) is known, the data object should be transferred to a memory location that is accessible by application 22. As stated above, application queue manager 44 produces and maintains whatever queues are required by the applications (i.e., application 22) running on server 12. In this case, since application 22 uses application queue 56, data object 14 should be transferred to application queue 56 so that it is available to application 22.

A data object transfer process 58, which is responsive to the intended recipient (i.e., application 22) being determined, facilitates the transfer of data object 14 from communication queue 40 to application queue 56. This transfer is accomplished by modifying the pointers within the respective header cells 38, 54 of the communication queue 40 and the application queue 56.

Continuing with the above stated example, currently header cell 38 for communication queue 40 appears as follows:

Communication Queue 40
000000

Further, header cell 54 for application queue 56 appears as follows:

Application Queue 56

Data object transfer process 58, via buffer dequeuing process 230 of communication queue manager 26, dissociates Buffer 1 (i.e., 000000 _{base 8}) from the header cell 38 of communication queue 40. Therefore, header cell 38 (in the particular example) would now be empty. Data object transfer process 58, via buffer enqueueing process 112 of application queue manager 44, would subsequently associate Buffer 1 (i.e., 000010 _{base 8}) with the header cell 54 of application queue 56. This results in header cell 38 of communication queue 40 being modified to remove the pointer that points to memory address 000000 _{base 8} and header cell 54 of application queue 56 being modified to add a pointer that points to 000000 _{base 8}, thus transferring data object 14 from communication queue 40 to application queue 56 without changing the physical location of data object 14.

In some embodiments, dissociating a buffer from a header cell does not delete the data stored in that buffer. Further, since the buffer was never released to an availability queue, the buffer (and, therefore, the data) cannot be overwritten.

After the above-described steps, header cells 38 and 54 appear as follows:

| Communication Queue 40 | Application Queue 56 |
|---|---|
| | 000000 |

Therefore, the data object 14, which is stored in Buffer 1 at memory location 000000 _{base 8} is now available and accessible by application 22. Accordingly, a communication buffer has become, in essence, an application buffer.

Once application 22 reads data object 14 from Buffer 1, buffer dequeueing process 128 of application queue manager 44 dissociates Buffer 1 (i.e., memory address 000000 _{base 8}) from application queue 56 by removing the pointer in header cell 54 that points to this memory address. Buffer 1 is then released to the availability queue so that additional data objects subsequently received can be written to it. Depending on the way that the system is configured, Buffer 1 can be released to: the communication availability queue (if buffer ownership remained with the communication queue manager); the application availability queue (if buffer ownership was transferred at the time the header cells were modified); or a general availability queue (to be discussed below).

While the process 10 described above includes a data object transfer process 58 that transfers a data object 14 from a communication queue buffer to an application queue buffer, other arrangements are possible. Specifically, data retrieval process 10 can be configured in a manner that makes data object transfer process 58 not required. Specifically, application queue manager 44 can be configured so that once the received data object 14 is written to Buffer 1 (i.e., the first available communication buffer in the communication availability queue), the buffer enqueueing process 112 of the application queue manager 44 can directly associate that communication buffer (i.e., Buffer 1) with an application queue. As earlier, this association occurs by modifying the header cell associated with the application queue to include a pointer that points to the communication buffer into which the data object was written. In this configuration, process 10 is streamlined in that only one association and, therefore, one header cell modification has to be made.

Alternatively, the received data objects could be directly written to application buffers (as opposed to communication buffers), such that the header cell associated with the application queue would include a pointer that points to the application buffer into which the data object was directly written.

While the buffers are described above as being one word wide, this is for illustrative purposes only, as they may be as wide as needed by the application or process requesting the queue.

While the queues above were described as being one buffer wide, other arrangements are possible. Specifically, the application or process can specify that the queues it needs can be as wide or as narrow as desired. For example, if a third application (not shown) requested an application queue that was eight words deep but two words wide, a total of sixteen buffers would be used having a total size of sixty-four bytes, as each thirty-two bit buffer includes four one-byte words. The header cell (not shown) associated with this queue would have placeholders for only eight pointers. Therefore, each pointer would point to the beginning of a two buffer storage area. Accordingly, the starting address of the second buffer of each two buffer storage area would not be immediately known nor directly addressable. Naturally, this third application would have to be configured to process data in two word chunks and, additionally, write process 118 and read process 120 would have to be capable of respectively writing and reading data in two word chunks.

The communication and application buffer availability queues described above include multiple buffers, each of which has the same width (i.e., one word). While all the buffers in an availability queue should be the same width, queue managers 26, 44 allow for multiple availability queues, thus accommodating multiple buffer widths. For example, if the third application described above had requested a queue that was two words wide and eight words deep, application memory address space 102 could be apportioned into eight two-word chunks in addition to the one-word chunks used by queues 56, 110. The one-word buffers would be placed into a first application availability queue (for use by queues 56, 110) and the two-word buffers would be placed into a second application availability queue (for use by the new, two-word wide, queue). When a queue object is received for either queue 56 or queue 110, buffer enqueuing process 112 would obtain a one-word buffer from the first application availability queue. However, when a queue object is received for the new, two-word wide, queue, buffer enqueuing process 112 would obtain a two-word buffer from the second application availability queue.

As described above, each buffer has a physical address associated with it, and that physical address is the address of the buffer within the memory storage space from which it was apportioned. In the beginning of the above-stated example, application queue 56 was described as including four buffers (i.e., Buffers 1-4) having an address range from 000000-000017 _{base 8} and application queue 110 was described including eight buffers (i.e., Buffers 5-12) having an address range from 00020-000057 _{base 8}. Therefore, the starting address of application queue 56 is 000000 _{base 8} and the starting address of application queue 110 is 000020 _{base 8}. Unfortunately, some programs or processes may have certain limitations concerning the addresses of the memory devices to which they can write. If applications 22, 24 or processes 204, 206 have any limitations concerning the memory addresses of the buffers used to assemble their respective queues, their respective memory apportionment processes 100, 200 are capable of translating the address of any buffer to accommodate the specific address requirements of the application or process that the queue is being assembled for.

The amount of this translation is determined by the queue parameter that specifies the starting address of the queue (as provided to buffer configuration processes 108, 212). For example, if it is determined from the starting address queue parameter that application 22 (which owns application queue 56) can only write to queues having addresses greater than 100000 _{base 8}, the addresses if the buffers associated with application queue 56 can all be translated (i.e., shifted upward) by 100000 _{base 8}. Therefore, the addresses of application queue 56 would be as follows:

Application Queue 56

| Actual Memory Address | Translated Memory Address |
|---|---|
| 000020 | 100020 |
| 000024 | 100024 |
| 000030 | 100030 |
| 000034 | 100034 |
| 000040 | 100040 |
| 000044 | 100044 |
| 000050 | 100050 |
| 000054 | 100054 |

By allowing this translation, application 22 can think it is writing to memory address spaces within its range of addressability, yet the buffers actually being written to and/or read from are outside of the application's range of addressability. Naturally, the translation amount (i.e., 100000 _{base 8}) would have to be known by both the write process 118 and the read process 120 so that any read or write request made by application 22 could be translated from the translated address used by the application into the actual address of the buffer.

While communication queue manager 26 is described as tailoring the size of each communication queue in accordance with various criteria (e.g., the individual needs of the communication processes running on the system, the speed of the connection between server 12 and the remote computer, the needs of the application requesting the data object, for example), this is for illustrative purposes only. Specifically, each communication queue may be configured identically regardless of this criteria. For example, upon system startup, communication memory address space 42 may be automatically divided into thirty-two, eight buffer queues, which would be used, as needed, by the communication processes or sessions established. Therefore, while the communication queues would be configured in accordance with queue parameters, a common set of queue parameters would be used to configure all communication queues. The size and number of the queues and queue buffers would have to be properly allocated so that ample queues and buffers are always available for temporarily storing incoming data objects.

As described above, the intended recipient of a data object is designated by either a socket or port address. However, other forms of addressing are also possible. For example, the intended recipient designation can be in the form of an application identifier, in which the application (e.g., application 22) that made the data read request is identified.

While the above describes the queue buffers as being adjustable in size, other arrangements are possible. For example, the queue buffers may each be a physical bank of memory (such as one kilobyte of DRAM) and the queues may be assembled from these predefined and non-adjustable queue buffers.

While the transfer of a data object is described above as occurring when a pointer is transferred from the header cell of a first queue (i.e., a communication queue) to the header cell of a second queue (i.e., an application queue), this is not the only way that a data transfer can occur. Specifically, the actual content (i.e., the data object) of the buffer of the first queue can be copied to the buffer of the second queue.

While application queue manager 44 and communication queue manager 26 were described above as being separate and discrete systems, a general queue manager (not shown) can be used that apportions a common memory address space into a plurality of common buffers. This plurality of common buffers would form a general availability queue. Accordingly, whenever a communication process (e.g., processes 204, 206) or an application (e.g., applications 22, 24) requires buffers to form a queue, they are pulled from the general availability queue and, subsequently, released to the general availability queue.

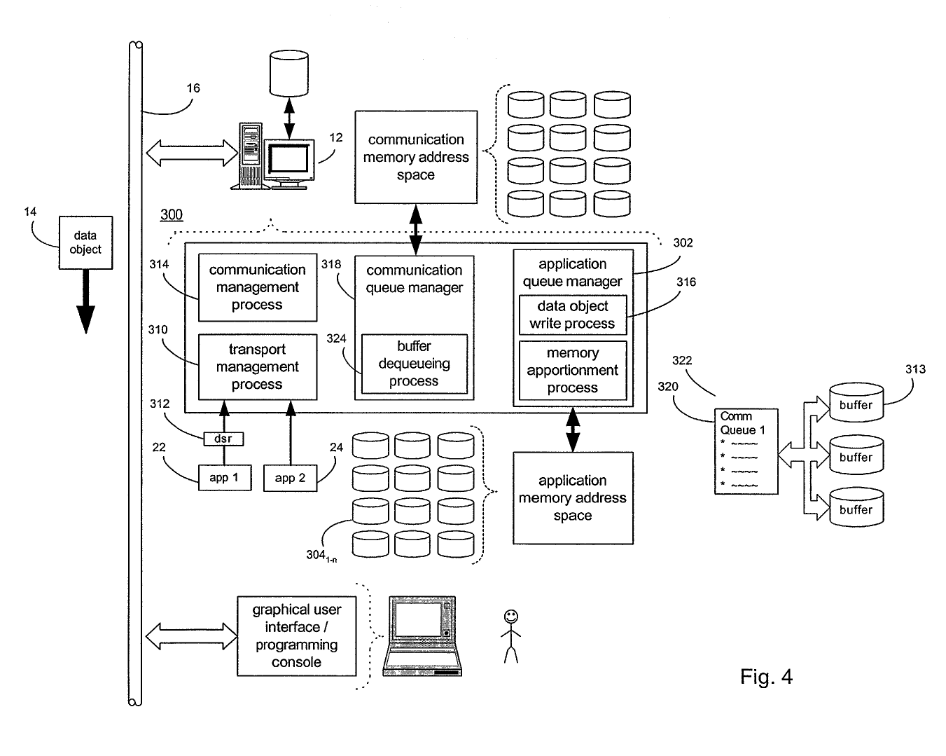

Referring to FIG. 4, a data transmission process 300 is shown. As earlier, an application queue manager 302 maintains a plurality of application buffers 304₁₋ₙ that are accessible by an application (e.g., application 22) running on server 12. Whenever transport management process 310 (such as the transport service utility in the Unisys® operating system) receives a data send request 312, a communication management process 314 (such as CMS or CPComm in the Unisys® operating system) transmits the data object 14 over network 16.

Prior to sending the data send request 312, the application wishing to send the data object obtains from application queue manager 302 an application buffer 313 (e.g., Buffer 1 at memory address 000000 _{base 8}) into which data object 14 is written. This application buffer 313 is retrieved from the plurality of application buffers 304₁₋ₙ (i.e., the application availability queue).

Data object write process 316 allows application 22 to write data object 14 to buffer 313. Accordingly, the data object 14 to be transmitted is now stored in buffer 313 (i.e., the first available application buffer retrieved from the plurality of application buffers 304₁₋ₙ).

Once data object write process 316 completes this writing procedure, application 22 sends the data send request 312 to the transport management process 310. This data send request includes the location of the data object 14 to be transferred. Therefore, data send request 312 includes an identifier that specifies that the data object 14 to be transmitted is located in buffer 313.

A communication queue manager 318 associates the application buffer(s) into which data object 14 was written with a header cell 320 for a communication queue 322 that is associated with (i.e., owned) by communication queue manager 318. This association process modifies the header cell 320 associated with communication queue 322 to include a pointer that indicates the memory address (000000 _{base 8}) of the buffer 313 into which data object 14 was written.

Once data object 14 is transmitted over network 16, a buffer dequeuing process 324 removes (from header cell 320) the pointer that points to buffer 313 and buffer 313 is released, i.e., once again available in the application availability queue. Therefore, header cell 320 only contains pointers that point to buffers containing data objects that need to be transmitted. Accordingly, when header cell 320 is empty, there are no data objects waiting to be transmitted over network 16.

As data transmission process 300 is an ongoing and repeating process, the content of header cell 320 will vary depending on various factors, such as the level of network congestion and traffic, and the level of server loading, for example.

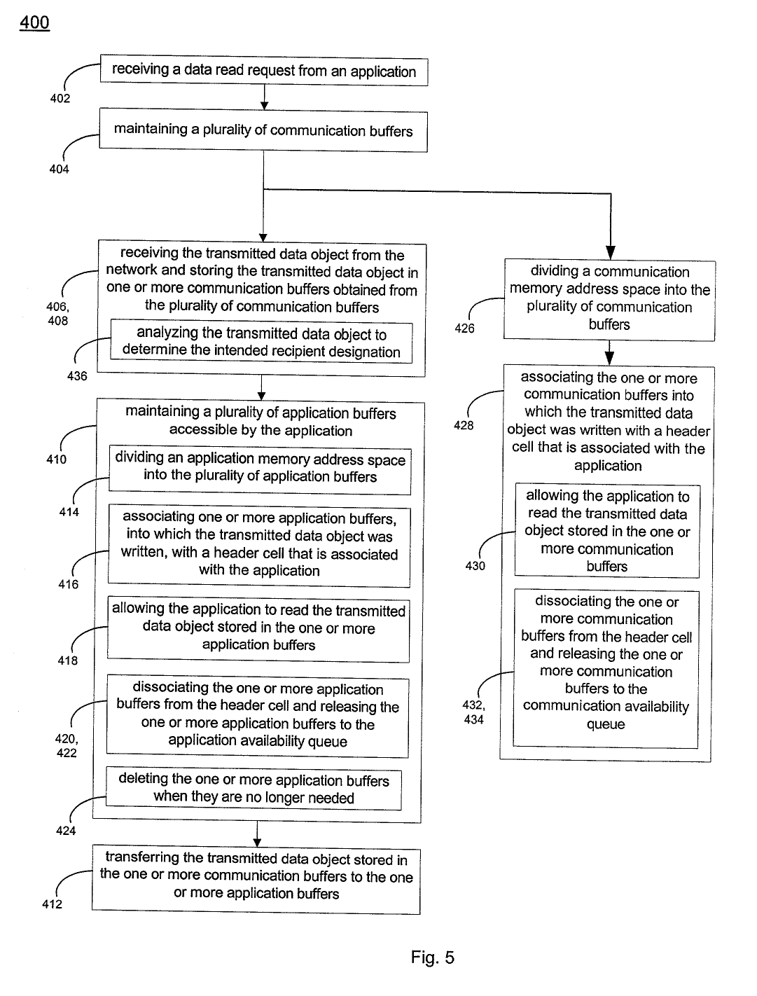

Referring to FIG. 5, a data retrieval method 400 for receiving a transmitted data object from a network is shown. A data read request is received 402 from an application. A plurality of communication buffers are maintained 404. The transmitted data object is received 406 from the network and stored 408 in one or more communication buffers obtained from the plurality of communication buffers.

A plurality of application buffers are maintained 410 that are accessible by the application. The transmitted data object that is stored in the one or more communication buffers is transferred 412 to the one or more application buffers. An application memory address space is divided 414 into the plurality of application buffers. Each application buffer has a unique memory address and the plurality of application buffers provides an application availability queue.

The application buffers, into which the transmitted data object was written, are associated 416 with a header cell that is associated with the application. The header cell includes a pointer for each of the one or more application buffers. Each pointer indicates the unique memory address of the application buffer associated with that pointer. The application is allowed 418 to read the transmitted data object stored in the one or more application buffers. The one or more application buffers are dissociated 420 from the header cell and released 422 to the application availability queue. The one or more application buffers are deleted 424 when they are no longer needed.

A communication memory address space is divided 426 into the plurality of communication buffers. Each communication buffer has a unique memory address and the plurality of communication buffers provides a communication availability queue. The one or more communication buffers, into which the transmitted data object was written, is associated 428 with a header cell that is associated with the application. The header cell includes a pointer for each of the one or more communication buffers. Each pointer indicates the unique memory address of the communication buffer associated with that pointer.

The application is allowed 430 to read the transmitted data object stored in the one or more communication buffers. The one or more communication buffers is dissociated 432 from the header cell and released 434 to the communication availability queue. The transmitted data object is analyzed 436 to determine an intended recipient designation and, thus, the intended recipient of the data object.

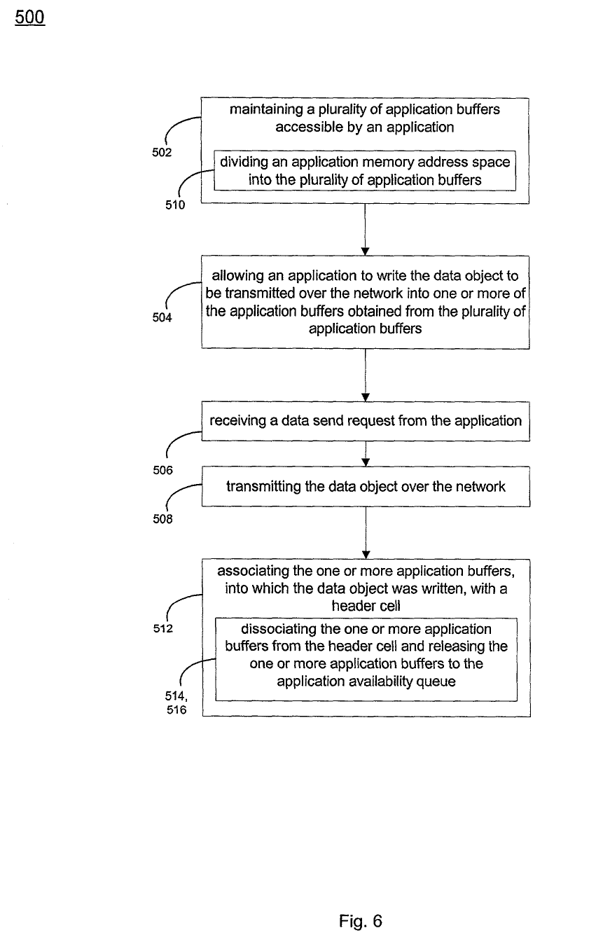

Referring to FIG. 6, a data transmission method 500 for transmitting a data object over a network is shown. A plurality of application buffers are maintained 502 that are accessible by an application. The application is allowed 504 to write the data object to be transmitted over the network into one or more of the application buffers obtained from the plurality of application buffers. A data send request is received 506 from the application. The data object is transmitted 508 over the network.

An application memory address space is divided 510 into the plurality of application buffers. Each application buffer has a unique memory address and the plurality of application buffers provides an application availability queue. The one or more application buffers, into which the data object was written, are associated 512 with a header cell. The header cell includes a pointer for each of the one or more application buffers. Each of these pointers indicates the unique memory address of the application buffer associated with that pointer. The one or more application buffers is dissociated 514 from the header cell and released 516 to the application availability queue.

A number of embodiments have been described. Other embodiments are within the scope of the following claims.

What is claimed is:

1. A data retrieval process, residing on a server, for receiving a transmitted data object from a network, the data retrieval process comprising:
a transport management process for receiving a data read request from an application;
a communication queue manager for maintaining a plurality of communication buffers; and
a communication management process, responsive to the data management process receiving the data read request from the application, for receiving the transmitted data object from the network and storing the transmitted data object in one or more of the communication buffers obtained from the plurality of communication buffers.

2. The process of claim 1 further comprising an application queue manager for maintaining a plurality of application buffers accessible by the application.

3. The process of claim 2 wherein the communications management process includes a data object transfer process for transferring the transmitted data object stored in the one or more communication buffers to the one or more application buffers.

4. The process of claim 3 wherein the application queue manager includes a memory apportionment process for dividing an application memory address space into the plurality of application buffers, wherein each the application buffer has a unique memory address and the plurality of application buffers provides an application availability queue.

5. The process of claim 4 wherein the application queue manager includes a buffer enqueueing process for associating the one or more application buffers, into which the transmitted data object was written, with a header cell that is associated with the application, wherein the header cell includes a pointer for each of the one or more application buffers, wherein each the pointer indicates the unique memory address of the application buffer associated with that pointer.

6. The process of claim 5 wherein the application queue manager includes a data object read process for allowing the application to read the transmitted data object stored in the one or more application buffers.

7. The process of claim 6 wherein the one or more application buffers associated with the header cell constitute a FIFO (first in, first out) queue associated with and useable by the application.

8. The process of claim 7 wherein the data object read process is configured to sequentially read the one or more application buffers in the FIFO queue in the order in which the one or more application buffers were written by the data object transfer process.

9. The process of claim 6 wherein the application queue manager includes a buffer dequeuing process, responsive to the data object read process reading data objects stored in the one or more application buffers, for dissociating the one or more application buffers from the header cell and allowing the one or more application buffers to be overwritten.

10. The process of claim 9 wherein the application queue manager includes a buffer deletion process for deleting the one or more application buffers when they are no longer needed by the application queue manager.

11. The process of claim 1 wherein the communication queue manager includes a memory apportionment process for dividing a communication memory address space into the plurality of communication buffers, wherein each the communication buffer has a unique memory address and the plurality of communication buffers provides a communication availability queue.

12. The process of claim 11 further comprising an application queue manager for associating the one or more communication buffers into which the transmitted data object was written with a header cell that is associated with the application, wherein the header cell includes a pointer for each of the one or more communication buffers, wherein each the pointer indicates the unique memory address of the communication buffer associated with that pointer.

13. The process of claim 12 wherein the application queue manager includes a data object read process for allowing the application to read the transmitted data object stored in the one or more communication buffers.

14. The process of claim 13 wherein the application queue manager includes a buffer dequeuing process, responsive to the data object read process reading data objects stored in the one or more communication buffers, for dissociating the one or more communication buffers from the header cell and releasing the one or more communication buffers to the communication availability queue.

15. The process of claim 1 wherein the transmitted data object includes an intended recipient designation.

16. The process of claim 15 wherein the intended recipient designation is a socket address.

17. The process of claim 15 wherein the communication management process includes a designation analysis process for analyzing the transmitted data object to determine the intended recipient designation.

18. The process of claim 1 wherein the communication buffers are each a proprietary cache memory device.

19. The process of claim 1 wherein the communication buffers are each a portion of system memory.

20. The process of claim 1 wherein the transport management process is a transport service utility in a Unisys operating system.

21. The process of claim 1 wherein the communication management process is a CMS process in a Unisys operating system.

22. The process of claim 1 wherein the communication management process is a CPComm process in a Unisys operating system.

23. A method for receiving a transmitted data object from a network, comprising:
receiving a data read request from an application;
maintaining a plurality of communication buffers; and
receiving the transmitted data object from the network and storing the transmitted data object in one or more communication buffers obtained from the plurality of communication buffers.

24. The method of claim 23 further comprising maintaining a plurality of application buffers accessible by the application.

25. The method of claim 24 further comprising transferring the transmitted data object stored in the one or more communication buffers to the one or more application buffers.

26. The method of claim 25 wherein the maintaining a plurality of application buffers includes dividing an application memory address space into the plurality of application buffers, wherein each application buffer has a unique memory address and the plurality of application buffers provides an application availability queue.

27. The method of claim 26 wherein the maintaining a plurality of application buffers includes associating one or more application buffers, into which the transmitted data object was written, with a header cell that is associated with the application, wherein the header cell includes a pointer for each of the one or more application buffers, wherein each pointer indicates the unique memory address of the application buffer associated with that pointer.

28. The method of claim 27 wherein the maintaining a plurality of application buffers includes allowing the application to read the transmitted data object stored in the one or more application buffers.

29. The method of claim 28 wherein the maintaining a plurality of application buffers includes dissociating the one or more application buffers from the header cell and releasing the one or more application buffers to the application availability queue.

30. The method of claim 29 wherein the maintaining a plurality of application buffers includes deleting the one or more application buffers when they are no longer needed.

31. The method of claim 23 wherein the maintaining a plurality of communication buffers includes dividing a communication memory address space into the plurality of communication buffers, wherein each communication buffer has a unique memory address and the plurality of communication buffers provides a communication availability queue.

32. The method of claim 31 further comprising associating the one or more communication buffers into which the transmitted data object was written with a header cell that is associated with the application, wherein the header cell includes a pointer for each of the one or more communication buffers, and each pointer indicates the unique memory address of the communication buffer associated with that pointer.

33. The method of claim 32 wherein the associating the one or more communication buffers includes allowing the application to read the transmitted data object stored in the one or more communication buffers.

34. The method of claim 33 wherein the associating the one or more communication buffers includes dissociating the one or more communication buffers from the header cell and releasing the one or more communication buffers to the communication availability queue.

35. The method of claim 23 wherein the transmitted data object includes an intended recipient designation and the receiving the transmitted data object includes analyzing the transmitted data object to determine the intended recipient designation.

36. A computer program product residing on a computer readable medium having a plurality of instructions stored thereon which, when executed by the processor, cause that processor to:
receive a data read request from an application;
maintain a plurality of communication buffers; and
receive a transmitted data object from a network and store the transmitted data object in one or more communication buffers obtained from the plurality of communication buffer

37. A data transmission process, residing on a server, for transmitting a data object over a network, the data transmission process comprising:
an application queue manager for maintaining a plurality of application buffers accessible by an application, wherein the application queue manager includes a data object write process for allowing an application to write the data object to be transmitted over the network into one or more of the application buffers obtained from the plurality of application buffers;
a transport management process for receiving a data send request from the application; and
a communication management process, responsive to the data management process receiving the data send request from the application, for transmitting the data object over the network.

38. The process of claim 37 wherein the application queue manager includes a memory apportionment process for dividing an application memory address space into the plurality of application buffers, wherein each the application buffer has a unique memory address and the plurality of application buffers provides an application availability queue.

39. The process of claim 38 further comprising an communication queue manager for associating the one or more application buffers, into which the data object was written, with a header cell that is associated with the communication queue manager, wherein the header cell includes a pointer for each of the one or more application buffers, wherein each the pointer indicates the unique memory address of the application buffer associated with that pointer.

40. The process of claim 39 wherein the communication queue manager includes a buffer dequeuing process, responsive to the communication management process transmitting the data object over the network, for dissociating the one or more application buffers from the header cell and releasing the one or more application buffers to the application availability queue.

41. The process of claim 37 wherein the communication buffers are each a proprietary cache memory device.

42. The process of claim 37 wherein the communication buffers are each a portion of system memory.

43. The process of claim 37 wherein the transport management process is a transport service utility in a Unisys operating system.

44. The process of claim 37 wherein the communication management process is a CMS process in a Unisys operating system.

45. The process of claim 37 wherein the communication management process is a CPComm process in a Unisys operating system.

46. A method for transmitting a data object over a network, comprising:
maintaining a plurality of application buffers accessible by an application;
allowing an application to write the data object to be transmitted over the network into one or more of the application buffers obtained from the plurality of application buffers;
receiving a data send request from the application; and
transmitting the data object over the network.

47. The method of claim 46 wherein the maintaining a plurality of application buffers includes dividing an application memory address space into the plurality of application buffers, wherein each application buffer has a unique memory address and the plurality of application buffers provides an application availability queue.

48. The method of claim 47 further comprising associating the one or more application buffers, into which the data object was written, with a header cell, wherein the header cell includes a pointer for each of the one or more application buffers, wherein each pointer indicates the unique memory address of the application buffer associated with that pointer.

49. The method of claim 48 wherein the associating the one or more application buffers includes dissociating the one or more application buffers from the header cell and releasing the one or more application buffers to the application availability queue.

50. The method of claim 46 wherein the communication buffers are each a proprietary cache memory device.

51. The method of claim 46 wherein the communication buffers are each a portion of system memory.

52. A computer program product residing on a computer readable medium having a plurality of instructions stored thereon which, when executed by the processor, cause that processor to:
maintain a plurality of application buffers accessible by an application;
allow an application to write the data object to be transmitted over the network into one or more of the application buffers obtained from the plurality of application buffers;
receive a data send request from the application; and
transmit the data object over the network.
